(19) United States
(12) Patent Application Publication
(10) Pub. No.: US 2026/0332930 A1
(43) Pub. Date: Oct. 22, 2026

(54) MEMS MICROPHONE

(71) Applicant: AAC ACOUSTIC TECHNOLOGIES (SHENZHEN) CO., LTD., Shenzhen (CN)

(72) Inventors: Ting Kang, Shenzhen (CN); Zhaoping Chen, Shenzhen (CN)

(21) Appl. No.: 19/307,044

(22) Filed: Aug. 22, 2025

Related U.S. Application Data
(63) Continuation of application No. PCT/CN2025/089374, filed on Apr. 16, 2025.

(51) Int. Cl. H04R 1/08; H04R 1/02

(52) U.S. Cl. CPC H04R 1/08; H04R 1/02; H04R 2201/003

(57) ABSTRACT

The present disclosure discloses a MEMS microphone including a housing including a receiving space and a sound hole, an ASIC chip, a MEMS chip including a back cavity, and a baffle fixed on the housing and dividing the receiving space into a front cavity and a rear cavity isolated from each other. The MEMS chip is disposed on the baffle and received in the front cavity. The baffle includes a first venting hole wholly covered by the MEMS chip, and a second venting hole configured to connect the front cavity and the real cavity. A diameter of the first venting hole is larger than a diameter of the second venting hole; the diameter of the second venting hole is in a range of 5-50 μm. The MEMS microphone in the present disclosure has larger attenuation under 1 kHz frequency response.

### FIELD OF THE PRESENT DISCLOSURE

The present disclosure relates to electric-acoustic conversion technologies, especially relates to a MEMS microphone applied in portable mobile terminals.

### DESCRIPTION OF RELATED ART

Generally, MEMS microphone adopted for acoustic signal detection and process, includes a housing, a circuit board mounted on the housing, a MEMS chip and an ASIC chip received in the housing.

Frequency response is a key index of MEMS microphone. Especially low-frequency response under 1 kHz has a significant impact on the overall sound quality of MEMS microphone.

In related art, the low-frequency response characteristics of a MEMS microphone are mainly determined by the MEMS chip and the size of the package cavity. For obtaining larger attenuation under 1 kHz frequency response, it is necessary to optimize the design of the MEMS chip, such as adjusting the thickness of the membrane, the porosity of the back plate, the stress distribution parameters, or the size of the back cavity of the MEMS microphone. However, it may increase the complexity of MEMS chip, thereby raising its production cost and prolonging research period.

Therefore, it is necessary to provide an improved mems microphone to overcome the problems mentioned above.

### SUMMARY OF THE INVENTION

One object of the present disclosure is to provide a MEMS microphone with larger attenuation under 1 kHz frequency response.

The MEMS microphone includes a housing including a receiving space, and a sound hole penetrating thereon and connected with the receiving space; an ASIC chip received in the receiving space; a MEMS chip including a back cavity; and a baffle fixed on the housing, dividing the receiving space into a front cavity and a rear cavity isolated from each other; wherein the MEMS chip is disposed on the baffle and received in the front cavity; the baffle includes a first venting hole connected with the back cavity and wholly covered by the MEMS chip, and a second venting hole configured to connect the front cavity and the real cavity; the first venting hole and the second venting hole are both round; a diameter of the first venting hole is larger than a diameter of the second venting hole; the diameter of the second venting hole is in a range of 5-50 μm.

As an improvement, the back cavity is round; the diameter of the first venting hole is smaller than a diameter of the back cavity.

As an improvement, the housing includes a shell, and a substrate disposed on the shell and jointly enclosed the receiving space with the shell; the baffle is fixed on the substrate; the substrate includes a concave portion depressed along a direction away from the shell for enclosing the rear cavity with the baffle.

As an improvement, the baffle is mounted on the substrate via glue or solder paste.

As an improvement, the baffle and the substrate are integrally molded.

As an improvement, the ASIC chip is mounted on the baffle and located inside the front cavity.

As an improvement, the first venting hole is spaced apart from the second venting hole.

As an improvement, the sound hole is provided on the shell.

As an improvement, the substrate is a circuit board.

### BRIEF DESCRIPTION OF THE DRAWINGS

The present disclosure will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

FIG. 1 is a cross-sectional view of a MEMS microphone in accordance with a first exemplary embodiment of the present disclosure.

FIG. 2 is a cross-sectional view of a MEMS microphone in accordance with a second exemplary embodiment of the present disclosure.

FIG. 3 is a schematic diagram of the sensitivity of the MEMS microphone at different frequencies when a diameter of a second venting hole is 0 μm, 21 μm and 30 μm respectively.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

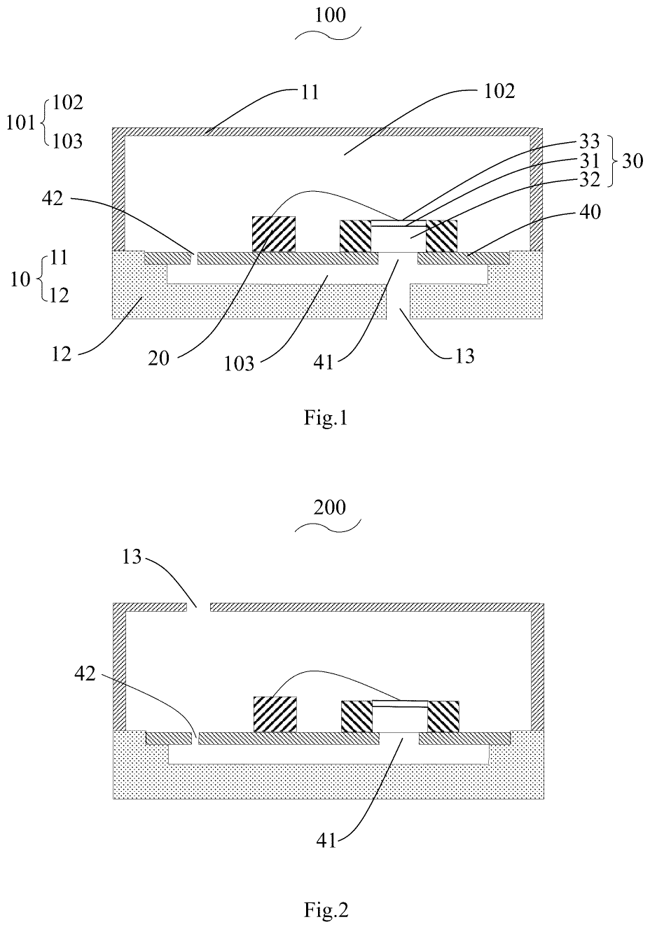

Please refer to FIGS. 1-2, a MEMS microphone 100 provided by a first exemplary embodiment of the present disclosure includes a housing 10 including a receiving space 101, an ASIC chip 20 received in the receiving space 101, and a MEMS chip 30 including a back cavity 32. Furthermore, the MEMS chip 30 includes a membrane 31 and a back plate 33 opposite to the membrane 31. The membrane 31 is driven to vibrate resulting in capacitance change between the membrane 31 and the back plate 33. Thus, an electrical signal generated based on the capacitance change is transmitted to the ASIC chip 20 for further process.

Moreover, the housing 100 includes a sound hole 13 penetrating thereon and connected with the receiving space 101. The sound wave is transmitted to the MEMS chip 30 via the sound hole 13. Specifically, the housing 10 includes a shell 11, and a substrate 12 disposed on the shell 11 and jointly enclosed the receiving space 101 with the shell 11. Furthermore, the substate 11 is a circuit board.

As shown in FIG. 1, the MEMS microphone 100 further includes a baffle 40 fixed on the housing 10. The baffle 40 is configured to divide the receiving space 101 into a front cavity 102 and a rear cavity 103 isolated from each other. And, the MEMS chip 30 is disposed on the baffle 40 and received in the front cavity 102. Moreover, the baffle 40 includes a first venting hole 41 connected with the back cavity 32 and wholly covered by the MEMS chip 30, and a second venting hole 42 configured to connect the front cavity 102 and the real cavity 103. The first venting hole 41 and the second venting hole 42 are both round and spaced apart from each other. The back cavity 32 is also round, which means that a projection of the back cavity 32 along a vertical direction or a vibration direction of the membrane 31 is round.

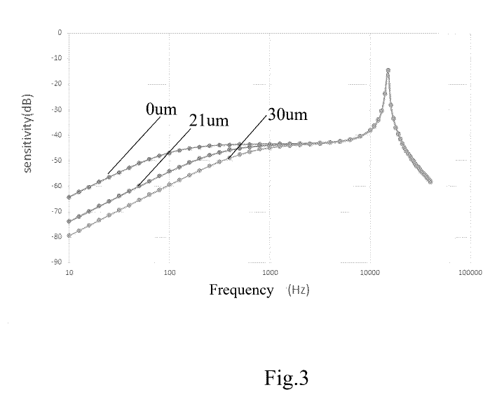

In one embodiment, the frequency response of the MEMS microphone 100 could be reduced by adjusting the diameter of the second venting hole 42. As shown in FIG. 3, with the increase of the diameter of the second venting hole 42 from 0 to 30 μm, the sensitivity of the MEMS microphone 100 under 1 kHz gradually decreases. In conclusion, the larger the diameter of the second venting hole 42, the larger the attenuation of the low-frequency response of the MEMS microphone 100. In order to ensure sound quality of the MEMS microphone under voice grade frequency, the diameter of the second venting hole 42 is arranged in a range of 5-50 μm. Besides, the diameter of the first venting hole 41 is smaller than a diameter of the back cavity 32, and larger than the diameter of the second venting hole 42. Thus, the low-frequency response of the MEMS microphone 100 could be reduced only by adjusting the diameter of the second venting hole 42, thereby reducing the research cost and period.

Furthermore, the ASIC chip 20 is mounted on the baffle 40 and located inside the front cavity 102. The baffle 40 is mounted on the substrate 12. The substrate 12 includes a concave portion 121 depressed along a direction away from the shell 11 for enclosing the rear cavity 103 with the baffle 40. In one embodiment, the baffle 40 is fixed on the substrate 12 via glue or solder paste. Or, the baffle 40 and the substrate 12 are integrally molded.

As shown in FIG. 1, the sound hole 31 is provided on the substrate 12. The membrane 31 is located on a side of the back plate 33 facing the substrate 12. The first venting hole 41 is opposite to the sound hole 13 along a vibration direction of the membrane 31.

As shown in FIG. 2, the only difference of the MEMS microphone 200 from the MEMS microphone 100 in FIG. 1 is that the sound hole 32 is provided on the shell 13. In this manner, a plurality of through holes should be provided on the back plate 33 to enable the sound wave transmitted to the membrane 31, or the membrane 31 is arranged to be located at a side of the back plate 33 away from the substrate 12.

Compared with the related art, the mems microphone in the present disclosure obtains larger attenuation of the low-frequency response under 1 kHz only by adjusting the diameter of the second venting hole of the baffle, thereby reducing the research cost and period.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A MEMS microphone comprising:
a housing including a receiving space, and a sound hole penetrating thereon and connected with the receiving space;
an ASIC chip received in the receiving space;
a MEMS chip including a back cavity; and
a baffle fixed on the housing, dividing the receiving space into a front cavity and
a rear cavity isolated from each other; wherein
the MEMS chip is disposed on the baffle and received in the front cavity; the baffle comprises a first venting hole connected with the back cavity and wholly covered by the MEMS chip, and a second venting hole configured to connect the front cavity and the real cavity; the first venting hole and the second venting hole are both round; a diameter of the first venting hole is larger than a diameter of the second venting hole; the diameter of the second venting hole is in a range of 5-50 μm.

2. The MEMS microphone as described in claim 1, wherein the back cavity is round; the diameter of the first venting hole is smaller than a diameter of the back cavity.

3. The MEMS microphone as described in claim 1, wherein the housing comprises a shell, and a substrate disposed on the shell and jointly enclosed the receiving space with the shell; the baffle is fixed on the substrate; the substrate includes a concave portion depressed along a direction away from the shell for enclosing the rear cavity with the baffle.

4. The MEMS microphone as described in claim 1, wherein the baffle is mounted on the substrate via glue or solder paste.

5. The MEMS microphone as described in claim 1, wherein the baffle and the substrate are integrally molded.

6. The MEMS microphone as described in claim 1, wherein the ASIC chip is mounted on the baffle and located inside the front cavity.

7. The MEMS microphone as described in claim 1, wherein the first venting hole is spaced apart from the second venting hole.

8. The MEMS microphone as described in claim 3, wherein the sound hole is provided on the shell.

9. The MEMS microphone as described in claim 1, wherein the substrate is a circuit board.
